(19) United States
(12) Patent Application Publication
(10) Pub. No.: US 2026/0167561 A1
(43) Pub. Date: Jun. 18, 2026

(54) APPARATUS AND METHOD FOR IMPROVING GLASS SHEET SURFACE QUALITY

(71) Applicant: CORNING INCORPORATED, CORNING, NY (US)

(72) Inventors: Chu-Hsiang Chiu, Changhua (TW); Wen Chun Hung, Taichung City (TW); Yi-Hsien Wang, Taoyuan City (TW)

(21) Appl. No.: 19/125,112

(22) PCT Filed: Nov. 1, 2023
(86) PCT No.: PCT/US2023/036583

§ 371 Date: Apr. 28, 2025

Related U.S. Application Data
(60) Provisional application No. 63/423,621, filed on Nov. 8, 2022.

(51) Int. Cl. C03C 23/00

(52) U.S. Cl. CPC C03C 23/0075

(57) ABSTRACT

A method and apparatus for manufacturing a glass article that includes forming the glass article in a forming apparatus, the glass article including a first major surface and a second major surface parallel to the first major surface, and directing a flow of gas along at least one of the first major surface or the second major surface for an amount and time sufficient to reduce the adherence of particles on the first major surface or the second major surface.

### CROSS REFERENCE TO RELATED APPLICATION

This application claims the benefit of priority under 35 U.S.C. § 119 of U.S. Provisional Application Ser. No. 63/423621 filed on Nov. 8, 2022, the content of which is relied upon and incorporated herein by reference in its entirety.

### FIELD

The present disclosure relates generally to apparatuses and methods for improving glass sheet surface quality and more particularly apparatuses and methods for reducing adhered particles on glass sheet surfaces.

### BACKGROUND

In the production of glass articles, such as glass sheets for display applications, including televisions and hand held devices, such as telephones and tablets, there are typically multiple processing steps that can involve glass particle generation, including when glass sheets are separated from a glass ribbon and moved for further processing. The generation of such particles can create an environment where they adhere to major surfaces of glass articles, such as glass sheets, during processing. Given that there is a trend for higher resolution displays, it is desirable to minimize the amount of particles present on such articles.

### SUMMARY

Embodiments disclosed herein include a method for manufacturing a glass article. The method includes forming the glass article in a forming apparatus, wherein the glass article includes a first major surface and a second major surface parallel to the first major surface. The method also includes directing a flow of gas along at least one of the first major surface or the second major surface for an amount and time sufficient to reduce the adherence of particles on the first major surface or the second major surface.

Embodiments disclosed herein also include an apparatus for manufacturing a glass article. The apparatus includes a forming apparatus configured to form the glass article, the glass article including a first major surface and a second major surface parallel to the first major surface. The apparatus also includes a gas flow apparatus configured to direct a flow of gas along at least one of the first major surface or the second major surface for an amount and time sufficient to reduce the adherence of particles on the first major surface or the second major surface.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic side view of a stage of an example glass sheet separation process;

FIG. 3 is a schematic side view of another stage of an example glass sheet separation process;

FIG. 4 is a schematic side view of yet another stage of an example glass sheet separation process;

FIG. 5 is a schematic side view of still yet another stage of an example glass sheet separation process;

FIG. 6 is an perspective view of a glass sheet;

FIG. 7 is a schematic perspective view of steps of a glass sheet manufacturing process;

FIG. 8 is top schematic perspective view of steps of a glass sheet manufacturing process in accordance with embodiments disclosed herein;

FIG. 9 is a side schematic perspective view of steps of a glass sheet manufacturing process in accordance with embodiments disclosed herein; and

FIGS. 10A-10C are, respectively, top, side, and bottom schematic views of a gas flow conduit in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein-for example up, down, right, left, front, back, top, bottom-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “particles” refers to any type of particles that can be present on a surface, such as glass particles and dust particles.

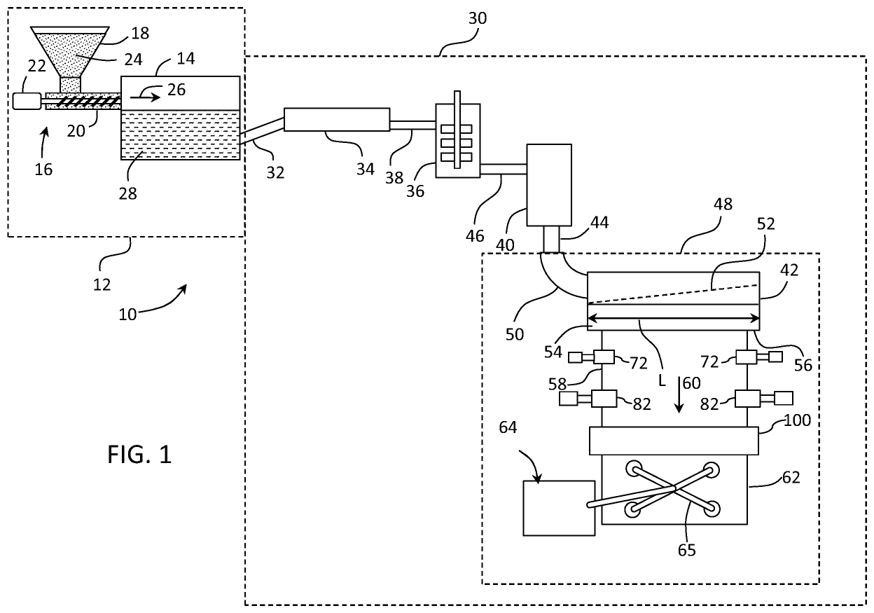

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

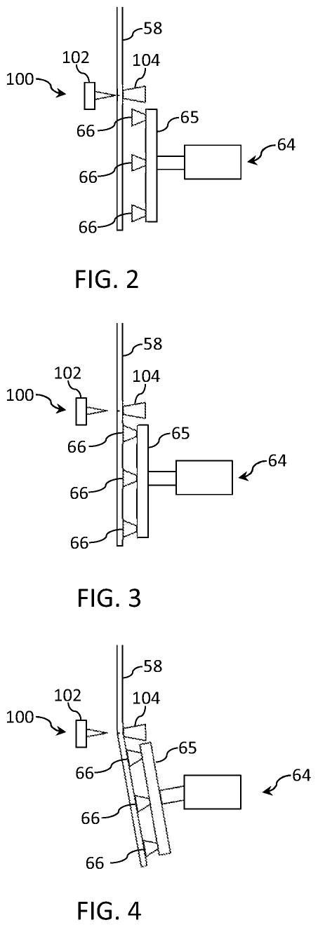

FIG. 2 shows a schematic side view of a stage of an example glass sheet separation process. As shown in FIG. 2, glass separation apparatus 100 includes scoring mechanism 102 and nosing 104, wherein scoring mechanism 102 and nosing 104 are positioned on opposite sides of glass ribbon 58. In the stage shown in FIG. 2, scoring mechanism 102 moves across the glass ribbon 58 in the widthwise direction (in a direction into and out of the plane of FIG. 2 as shown) and imparts a widthwise score line across the glass ribbon 58. In addition, in the stage shown in FIG. 2, gripping tool 65 has not yet engaged glass ribbon 58, although engagement while scoring is also known in the art and commonly practiced.

While scoring mechanism 102 is shown in FIG. 2 as a mechanical scoring mechanism, such as a mechanism comprising a score wheel, it is to be understood that embodiments herein include other types of scoring mechanism, such as, for example, laser scoring mechanisms. When scoring mechanism 102 comprises a score wheel, the score wheel may be mounted on a ball bearing pivot which is secured to a shaft which is in turn mounted on a linear actuator (air cylinder) that moves the score wheel towards the glass ribbon 58 so it can be drawn across and score a side of the ribbon.

Nosing 104 may comprise a resilient material, such as silicon rubber. In certain exemplary embodiments, nosing 104 may be a conformable nosing that has a bowed shape of the glass ribbon 58 as disclosed, for example, in U.S. Pat. No. 8,051,681, the entire disclosure of which is incorporated by reference. Nosing 104 may also be in fluid communication with a vacuum source (not shown) to enhance engagement between the glass ribbon 58 and the nosing, as disclosed, for example, in U.S. Pat. No. 8,245,539, the entire disclosure of which is incorporated herein by reference.

FIG. 3 shows a schematic side view of another stage of an example glass sheet separation process wherein scoring mechanism 102 has disengaged glass ribbon 58 and gripping tool 65, including gripping elements 66, is actuated by robot 64 to engage glass ribbon 58. Gripping elements 66 may, for example, comprise a resilient material, such as silicone rubber, and may, in certain exemplary embodiments, comprise a cup-shaped resilient material that may be in fluid communication with a vacuum source (not shown) to enhance engagement between the glass ribbon 58 and the gripping elements 66 (gripping elements comprising cup-shaped material in fluid communication with a vacuum source are hereinafter referred to as vacuum cups).

As shown in FIG. 3, while the gripping tool 64, including gripping elements 66, imparts a pulling force on glass ribbon 58, the pulling force is not sufficient to substantially bend the glass ribbon 58 away from the draw or flow direction 60. FIG. 4, however, shows a schematic side view of yet another stage of an example glass sheet separation process wherein gripping tool 65 has been further actuated by robot 64, thereby imparting a pulling force that is sufficient to begin to bend the portion of glass ribbon 58 extending below nosing 104 away from the draw or flow direction 60. However, as shown in FIG. 4, the pulling force is not yet sufficient to substantially separate the portion of the glass ribbon 58 extending below nosing 104 from the rest of the glass ribbon 58.

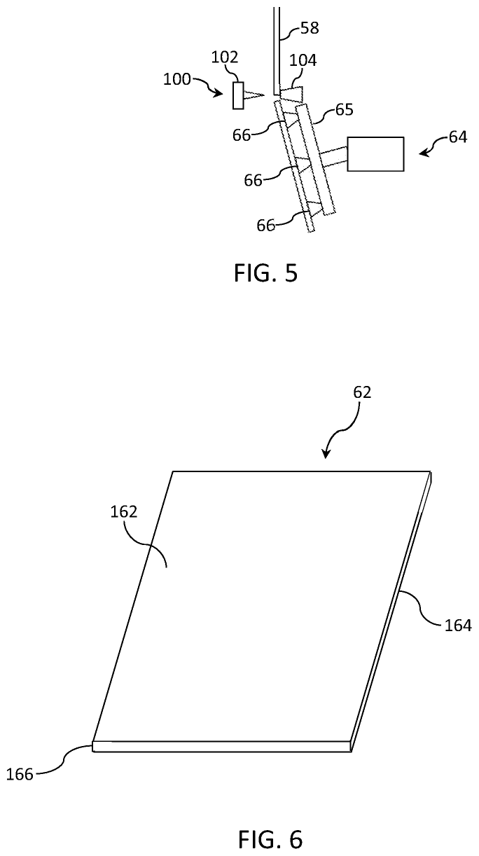

FIG. 5 shows a schematic side view of still yet another stage of an example glass sheet separation process wherein gripping tool 65 has been further actuated by robot 64, thereby imparting a pulling force that is sufficient to separate the portion of the glass ribbon 58 extending below nosing 104 (i.e., glass sheet 62) from the rest of the glass ribbon 58. The glass sheet 62 may then be transferred to, for example, a conveyor system for further processing.

FIG. 6 shows a perspective view of a glass sheet 62 having a first major surface 162, a second major surface 164 extending in a generally parallel direction to the first major surface 162 (on the opposite side of the glass sheet 62 as the first major surface) and an edge surface 166 extending between the first major surface 162 and the second major surface 164 and extending in a generally perpendicular direction to the first and second major surfaces 162, 164.

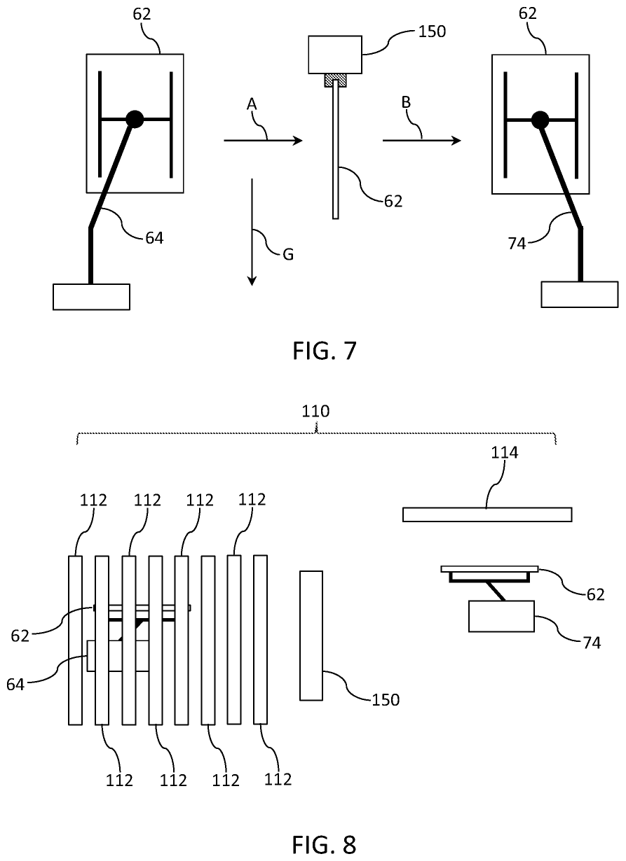

FIG. 7 shows a perspective view of steps of a glass sheet manufacturing process.

As shown in FIG. 7, glass sheet 62 is conveyed by robot 64 (i.e., first robot) toward weighing apparatus 150 as indicated schematically by arrow ‘A’ (in this processing step, glass sheet 62 is also conveyed away from forming apparatus). Subsequent to being weighed by weighing apparatus 150, glass sheet 62 is conveyed by robot 74 (i.e., second robot) from weighing apparatus 140 toward downstream processing apparatus (not shown) as indicated schematically by arrow ‘B.’

During the process shown in FIGS. 2-5 and 7, particles, such as small glass or dust particles can form on glass sheet 62, such as on first major surface 162 and/or second major surface 164 of glass sheet 62. For example, during separation of glass sheet 62 from glass ribbon 58 as shown in FIGS. 2-5, glass particles may develop as part of the scoring, bending, or separation process. In addition, glass particles may result during conveyance of glass sheet 62 by robots 64, 74, such as when a glass sheet is inadvertently dropped by robots 64, 74 (or otherwise inadequately secured to robots 64, 74). The presence of such glass particles in glass sheet processing environment can result in the formation of glass particles on glass sheet 62.

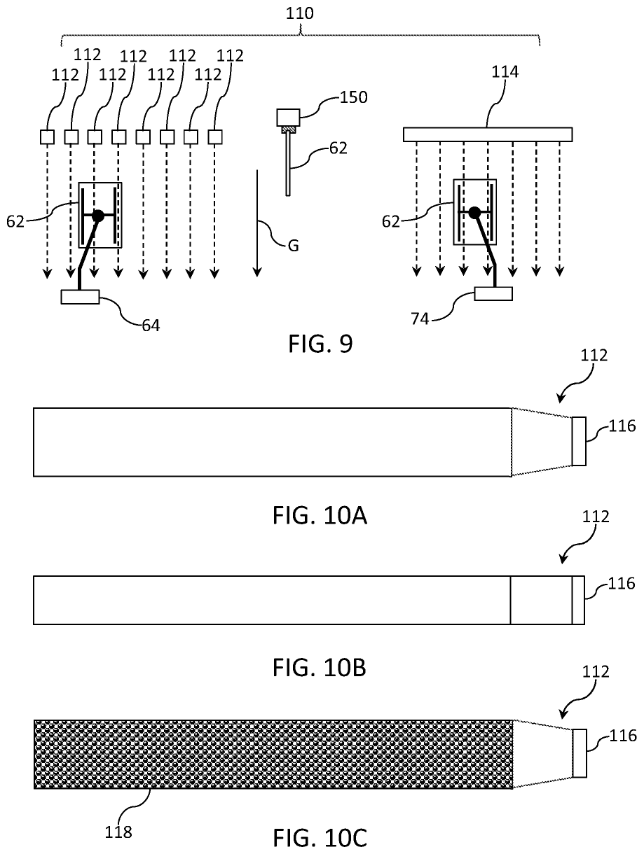

FIGS. 8 and 9, show, respectively, top and side schematic perspective views of steps of a glass sheet manufacturing process in accordance with embodiments disclosed herein. As shown in FIG. 8 glass sheet manufacturing process and apparatus includes a gas flow apparatus 110. Gas flow apparatus 110 includes a plurality of gas flow conduits, specifically a plurality of first gas flow conduits 112 and a second gas flow conduit 114. First gas flow conduits 112 extend over a region of gas flow apparatus 110 where robot 64 conveys glass sheet 62 from forming apparatus (not shown in FIGS. 8 and 9) to weighing apparatus 150. Second gas flow conduit 114 extends over a region of gas flow apparatus 110 where robot 74 conveys glass sheet 62 from weighing apparatus 150 to a downstream processing apparatus (not shown in FIGS. 8 and 9).

As shown in FIGS. 8 and 9, each of plurality of gas flow conduits 112, 114 extend along a longitudinal axis perpendicular to gravity (shown as arrow ‘G’ in FIG. 9) and flow gas (shown in FIG. 9 by dashed arrows) in a direction parallel to gravity. In addition, second gas flow conduit 114 extends in a longitudinal direction that is perpendicular to the longitudinal axes of first gas flow conduits 112.

As further shown in FIGS. 8 and 9, glass sheet 62 is conveyed by robots 64, 74 in a vertical orientation such that first major surface 162 and second major surface 164 extend along a direction parallel to gravity such that gas flowing from gas flow conduits 112, 114 is at least partially flowed by gravity along at least one of the first major surface 162 or the second major surface 164.

In certain exemplary embodiments, gas can be flowed into gas flow conduits 112, 114 through operation of a blower fan unit, which can be in fluid communication with gas flow conduits 112, 114 through one or more connecting conduits (not shown). In certain exemplary embodiments, gas comprises air.

FIGS. 10A-10C show, respectively, top, side, and bottom schematic views of a gas flow conduit 112 in accordance with embodiments disclosed herein. Gas flow conduit 110 comprises end cap 116 and bottom surface comprising a plurality of apertures 118 extending along a surface parallel to the longitudinal axis of gas flow conduit 112 and configured to flow gas out of the gas flow conduit 112. Alternatively stated, plurality of apertures 118 are configured to flow gas in a direction parallel to gravity such that gas flowing from gas flow conduits 112, 114 is at least partially flowed by gravity along at least one of the first major surface 162 or the second major surface 164 of glass sheet 62 when glass sheet 62 is conveyed (e.g., by robots 64, 74) within gas flow apparatus 110.

Embodiments disclosed herein include those in which gas is flowed along at least one of the first major surface 162 or the second major surface 164 of a glass sheet 62 for an amount and time sufficient to reduce the adherence of particles on the first major surface 162 or the second major surface 164. For example, gas may be flowed through gas flow apparatus 110 at a rate of from about 1 liter per second to about 10 liters per second, such as from about 3 liters per second to about 7 liters per second for a time of about 1 second to about 1 minute, such as from about 5 seconds to about 30 seconds.

Flowing gas along at least one of first major surface 162 or second major surface 164 of glass sheets 62 can, for example, reduce the adherence of particles on at least one of first major surface 162 or second major surface 164 by at least about 25%, such as at least about 30%, and further such as at least about 40%, and yet further such as at least about 45%, and still yet further such as at least about 50%, such as from about 25% to about 75%, and further such as from about 30% to about 70% as compared to a condition where a gas flow apparatus 110 is not used to flow gas along at least one of first major surface 162 or second major surface 164.

Embodiments disclosed herein can enable minimizing the adherence of particles, such as glass particles, on glass articles, such as glass sheets, which can result in the production of glass articles, such as glass sheets, with improved surface quality.

Embodiments disclosed herein can further enable improved efficiency of processing glass articles, such as glass sheets, in environments where particles, such as glass particles, are present by, for example, reducing the number of glass articles, such as glass sheets, that must be discarded for failing to meet quality requirements, such as surface quality requirements.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1. A method for manufacturing a glass article comprising:
forming the glass article in a forming apparatus, wherein the glass article comprises a first major surface and a second major surface parallel to the first major surface; and
directing a flow of gas along at least one of the first major surface or the second major surface for an amount and time sufficient to reduce the adherence of particles on the first major surface or the second major surface.

2. The method of claim 1, wherein the flow of gas is determined by gravity along at least one of the first major surface or the second major surface.

3. The method of claim 1, further comprising the step of conveying the glass article by a robot, wherein the step of directing a flow of gas is performed during the step of conveying the glass article by a robot.

4. The method of claim 3, wherein the step of conveying further comprises conveying the glass article from the forming apparatus to a weighing apparatus.

5. The method of claim 3, wherein the step of conveying further comprises conveying the glass article from a weighing apparatus to a downstream processing apparatus.

6. The method of claim 1, wherein the flow of gas is at a rate of from about 1 liter per second to about 10 liters per second and for a period of time from about 1 second to about 1 minute.

7. The method of claim 1, wherein the gas comprises air.

8. The method of claim 1, wherein the step of directing a flow of gas further comprises flowing the gas along a plurality of gas flow conduits extending along a longitudinal axis perpendicular to gravity.

9. The method of claim 8, wherein the step of directing a flow of gas further comprises flowing the gas from the gas flow conduits through a plurality of apertures extending along a surface parallel to the longitudinal axis of each conduit.

10. The method of claim 1, wherein the step of directing a flow of gas reduces the adherence of particles on at least one of the first major surface or the second major surface by at least about 25% as compared to a condition where the flow of gas is not used.

11. An apparatus for manufacturing a glass article comprising:
a forming apparatus configured to form the glass article, the glass article comprising a first major surface and a second major surface parallel to the first major surface; and
a gas flow apparatus configured to direct a flow of gas along at least one of the first major surface or the second major surface for an amount and time sufficient to reduce the adherence of particles on the first major surface or the second major surface.

12. The apparatus of claim 11, wherein the gas flow apparatus is configured to flow gas in a direction parallel to gravity.

13. The apparatus of claim 12, wherein the gas flow apparatus further comprises at least one gas flow conduit extending along a longitudinal axis perpendicular to gravity.

14. The apparatus of claim 13, wherein the at least one gas flow conduit comprises a plurality of apertures extending along a surface parallel to the longitudinal axis and configured to flow gas from the gas flow conduit.

15. The apparatus of claim 14, wherein the at least one gas flow conduit comprises a plurality of gas flow conduits extending along a plurality of longitudinal axes perpendicular to gravity.

16. The apparatus of claim 11, wherein the apparatus further comprises a robot configured to convey the glass article.

17. The apparatus of claim 16, wherein the robot is configured to convey the glass article from the forming apparatus to a weighing apparatus.

18. The apparatus of claim 16, wherein the robot is configured to convey the glass article from a weighing apparatus to a downstream processing apparatus.

19. A glass article made by the method of claim 1.

20. An electronic device comprising the glass article of claim 19.
